(19) United States
(12) Patent Application Publication
(10) Pub. No.: US 2026/0179202 A1
(43) Pub. Date: Jun. 25, 2026

(54) COMBINING STATE SPACE MODELS AND CONVOLUTIONAL NEURAL NETWORKS FOR GENERIC VIDEO QUALITY ASSESSMENT

(71) Applicants: Disney Enterprises, Inc., Burbank, CA (US); ETH Zürich (Eidgenössische Technische Hochschule Zürich), Zürich (CH)

(72) Inventors: Yang ZHANG, Duebendorf (CH); Felix YANG, Zürich (CH); Christopher Richard SCHROERS, Uster (CH)

(73) Assignees: Disney Enterprises, Inc., Burbank, CA (US); ETH Zürich (Eidgenössische Technische Hochschule Zürich), Zürich (CH)

(21) Appl. No.: 19/402,090

(22) Filed: Nov. 26, 2025

Related U.S. Application Data
(60) Provisional application No. 63/738,699, filed on Dec. 24, 2024.

(51) Int. Cl. G06T 7/00

(52) U.S. Cl. CPC G06T 7/0002; G06T 2207/10016; G06T 2207/20021; G06T 2207/20081; G06T 2207/20084; G06T 2207/30168

(57) ABSTRACT

Systems and methods are disclosed for automated video quality assessment using a hybrid neural network architecture. A sequence of video frames is received and partitioned into fragments, which are further subdivided into patches and encoded as tokens. The tokens are processed in parallel by a state space model, configured to extract temporal features, and by a convolutional neural network, configured to extract spatial features. The resulting feature representations are combined to form a unified embedding, which is input to a prediction head to generate local and overall quality scores indicative of the perceptual quality of the video. In some embodiments, frame-level supervision is employed during training by comparing predicted per-frame scores to reference scores, improving accuracy and granularity. The invention enables robust, efficient, and scalable video quality assessment suitable for use with streaming optimization, compression, and quality monitoring systems, and is adaptable to various neural network backbones.

### CROSS-REFERENCE TO RELATED APPLICATION

This application claims priority to U.S. Provisional Application No. 63/738,699 filed on Dec. 24, 2024, and entitled “Combining State Space Models and Convolutional Neural Networks for Generic Video Quality Assessment”, the contents of which are incorporated herein by reference in their entirety for all purposes.

### FIELD OF THE INVENTION

The present invention relates generally to the field of automated video quality assessment. More particularly, the invention pertains to systems and methods for evaluating the perceptual quality of digital video content using machine learning techniques.

### BACKGROUND

The widespread growth of digital video content across streaming services, social media, video conferencing, and entertainment platforms has created an ongoing need for accurate and efficient assessment of video quality. As consumption of video media continues to increase, ensuring a high-quality viewing experience while optimizing bandwidth, storage, and processing resources has become an important objective for various content providers, service operators, and technology developers.

Traditionally, video quality assessment (VQA) has relied on objective, algorithmic metrics such as Peak Signal-to-Noise Ratio (PSNR) and Structural Similarity Index Measure (SSIM). These full-reference metrics compare a compressed or processed video to an original, pristine reference version to quantify quality degradation. While these methods are computationally straightforward, they often exhibit poor correlation with subjective human perception, especially in complex or highly compressed video scenarios. Moreover, full-reference approaches are impractical for many real-world applications, such as user-generated content or live streaming, where reference videos are unavailable.

To address these shortcomings, machine learning-based VQA techniques have been developed. Notably, deep learning models, including convolutional neural networks (CNNs) and vision transformers, have demonstrated improved performance in predicting perceived video quality. Some recent metrics, such as Video Multimethod Assessment Fusion (VMAF), combine multiple quality indicators using machine learning regression frameworks. Others, such as AHIQ and MANIQA, focus on no-reference (blind) assessment by analyzing randomly sampled crops from video frames.

Despite these advances, existing approaches continue to face several challenges. Many models have difficulty capturing both global (temporal) and local (spatial) artifacts at the same time, which can result in an incomplete assessment of the distortions that affect perceived video quality. Additionally, transformer-based models often suffer from inefficiency and poor scalability, as their computational complexity increases quadratically with input size, making them impractical for processing long or high-resolution video sequences. Furthermore, conventional scanning and patch sampling strategies tend to introduce artificial discontinuities, which impede the model's ability to learn meaningful spatiotemporal relationships across video frames and fragments. Finally, most video quality assessment systems produce only a single, overall quality score for an entire video, which limits their usefulness in applications that require more granular, frame-level feedback.

Accordingly, there is an ongoing need for improved systems and methods that can efficiently and accurately assess the perceptual quality of digital video content in both reference and no-reference contexts.

### SUMMARY

Embodiments described herein pertain to systems and methods for efficiently and accurately evaluating the perceptual quality of digital video content using machine learning techniques. The disclosed systems and methods jointly capture both global and local distortions in video sequences, achieving greater computational efficiency and scalability compared to transformer-based models, while providing detailed quality feedback at both the frame and video level. In some embodiments, advanced data processing strategies are employed to reduce artificial discontinuities in feature extraction, enabling the model to better learn and represent spatiotemporal relationships within video content.

In accordance with various embodiments, the invention provides a hybrid neural network architecture for automated video quality assessment that does not require a reference video. The architecture integrates a state space model, such as a VideoMamba backbone, with a convolutional neural network (CNN) branch. The state space model efficiently captures temporal dependencies and global patterns across long video sequences, while the CNN branch specializes in identifying local spatial features and distortions within individual frames. Through this integration, the system extracts a comprehensive set of features from video data, resulting in more accurate and reliable quality predictions.

Some embodiments incorporate innovative scanning and data sampling strategies that preserve spatial locality and continuity. Rather than relying solely on conventional row-by-row or patch-based scanning, some embodiments utilize fragment-aware scanning schemes and space-filling curves, such as Z-scans. These approaches maintain relevant context for each pixel or video fragment, reducing the risk of missing subtle artifacts or introducing artificial boundaries that could impair learning. The scanning strategies are adaptable to both state space models and CNNs and can be configured for various video resolutions and lengths.

Further embodiments provide for high parameter efficiency and scalability, achieving state-of-the-art performance with fewer neural network parameters than many existing methods. The architecture is suitable for deployment in real-world environments, such as streaming services and production pipelines, where computational resources may be constrained. Additionally, embodiments support both video-level and frame-level quality prediction, enabling granular feedback for optimizing video compression, streaming, and other processing tasks.

According to some embodiments, a computer-implemented method for assessing a quality of a digital video is provided where the method includes: receiving, by one or more processors, a digital video comprising a sequence of video frames; processing the video frames, by a hybrid neural network architecture comprising a first visual quality assessment (VQA) branch utilizing a state space model and a second VQA branch utilizing a convolutional neural network, wherein the first VQA branch extracts temporal features from the sequence of video frames by the state space model and the second VQA branch extracts spatial features from individual frames by the convolutional neural network; combining the temporal and spatial features to form a unified feature representation; and generating, by the neural network architecture using the unified feature representation, at least one quality score indicative of a perceptual quality of the digital video.

Embodiments of the methods disclosed herein can further include one or more of the following additional steps: generating a quality score for each frame of the video, in addition to the at least one quality score for the sequence; providing frame-level supervision during training by comparing predicted frame-level quality scores to reference scores generated by a pre-trained image quality assessment model, and transforming the predicted frame-level quality scores via a learned mapping module to align with a distribution of the reference scores; organizing the tokens into a sequence according to a fragment-aware scanning strategy; and/or outputting the at least one quality score to a video streaming optimization, compression, or quality monitoring system.

In various implementations, embodiments can include one or more of the following features. Receiving and processing the video frames can include partitioning each frame into a grid of spatially uniform non-overlapping grid cells, and sampling a fragment from each grid cell. Sampling a fragment from each grid cell can include subdividing each fragment into a plurality of non-overlapping patches, and encoding each patch as a token for input to the neural network architecture. The fragment-aware scanning strategy can include scanning each frame fragment by fragment in sequence. The fragment-aware scanning strategy can include scanning all tokens of a fragment across multiple frames before moving to the next fragment. The state space model can include an input-dependent, selective state space model. The unified feature representation can be processed by a series of three-dimensional convolutional layers to regress local quality scores for each fragment or patch. The at least one quality score can be computed by aggregating local quality scores across all fragments, patches, or frames using averaging, weighted summation, or a learned fusion method. The state space model can be configured to process an input token sequence of a length (L) that is at least twice a maximum sequence length (Lmax) feasible for a Vision Transformer model of comparable computational resources, due to the linear computational complexity of the state space model. The first VQA branch can be configured as a technical quality branch that receives fragments sampled from raw-resolution frames without global downscaling, and the second VQA branch can be configured as an aesthetic quality branch that receives globally resized frames.

In addition to the methods described above and described further below, embodiments of the present disclosure are also directed to systems and devices that can be used to execute such methods. For example, one embodiment is directed to a computer system comprising a processor and a non-transitory computer readable medium coupled to the processor, the non-transitory computer readable medium stores computer instructions that, when executed by the processor, can implement any of the computer-implemented methods described herein.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIGS. 1A and 1B are a flowchart depicting the steps associated with a method of evaluating the perceptual quality of digital video content according to some embodiments;

FIG. 2 depicts a relationship between frames, a uniform grid, fragments, and patches according to some embodiments;

FIGS. 3A-3C are simplified diagrams depicting exemplary scanning schemes according to some embodiments;

FIG. 4 is a simplified diagram depicting a video quality assessment (VQA) model pipeline according to some embodiments;

FIG. 5 is a simplified diagram depicting a frame-level supervision pipeline used during training of a video quality assessment (VQA) model according to some embodiments; and

FIG. 6 is a simplified block diagram of a computing system in accordance with some embodiments.

### DETAILED DESCRIPTION

While a person of ordinary skill in the art will appreciate the meaning of the various technical terms used in this disclosure from the context of the discussion and the expertise and knowledge in the relevant field, for the convenience of the reader and to promote clarity, certain key terms, as used herein, are expressly defined below.

### Definitions

As used herein, a “frame” refers to a single still image that is one of a sequence of images constituting a digital video. Each frame captures the visual content of the video at a particular point in time.

A “video segment” refers to a contiguous subset of frames within a digital video, typically selected for localized processing or analysis.

A “fragment” refers to a spatial region of a video frame that is sampled from a predetermined cell of a uniform grid partitioning the frame. In the context of grid mini-patch sampling (GMS), a fragment is synonymous with a mini-patch and represents the sampled area within a grid cell. Each fragment is intended to capture representative local content from its portion of the frame, thereby preserving both local details and overall spatial coverage when considered across all grid cells.

In relevant literature, and as used herein, a “mini-patch” is typically a rectangular, region of pixels that is sampled from a cell of a uniform spatial grid imposed on a video frame. Thus, as used herein, the terms “mini-patch” and “fragment” are synonomous with each other and used interchangeably in this context.

As used herein, “raw-resolution fragments” refers to fragments sampled from frames at their native resolution, without prior global downscaling, thereby preserving fine-scale distortions and artifacts for technical quality assessment.

The term “resized frames” refers to frames that have been globally downscaled or otherwise reduced in resolution prior to feature extraction so that the network emphasizes global content, composition, and aesthetic attributes rather than small-scale distortions.

A “patch”, somewhat counter-intuitively, refers to a smaller, non-overlapping subregion of a mini-patch (i.e., fragment). Each mini-patch (fragment) is divided into a set of patches, with each patch comprising a rectangular block of pixels (for example, 16×16 pixels). Patches are encoded (flattened and embedded) to serve as the fundamental units (“tokens”) input to machine learning models, such as state space models or vision transformers, and are designed to capture fine-grained local features within each mini-patch. For clarity and consistency, the discussion below primarily uses the term “fragment” instead of “mini-patch” when referring to the larger sampled region and reserves the term “patch” for the smaller, sub-region of a fragment that serves as an input token to the neural network.

A “token” refers to a discrete unit of data derived from a patch, fragment, or other region of a frame, typically after transformation (such as flattening, embedding, or projection) into a vector or numerical representation suitable for input to a machine learning model. Tokens serve as the fundamental elements in sequential data processing architectures.

A “state space model” (sometimes abbreviated as “SSM”) refers to a mathematical or computational model that represents the evolution of an internal state over time as it processes a sequence of inputs. In the context of deep learning, a state space model is typically implemented as a neural network that updates its internal state at each time step based on the current input and the previous state, thereby capturing temporal dependencies within sequential data. As used herein, “state space model” includes input-dependent and selective state space models, such as Mamba and its variants.

A “convolutional neural network” (CNN) is a type of artificial neural network that employs convolutional layers to process data with a grid-like topology, such as images or video frames. CNNs are characterized by the use of learnable filters (kernels) that are convolved across input data to extract local spatial features and patterns, making them particularly effective for visual data analysis.

“Temporal features” refer to characteristics or representations extracted from a sequence of video frames that capture information about how visual content changes or evolves over time. Temporal features are typically derived by analyzing multiple frames in sequence to model motion, continuity, or other time-dependent aspects of video content.

“Spatial features” refer to characteristics or representations extracted from individual frames or regions within frames that capture information about the arrangement, patterns, textures, or structures present in the visual content at a single point in time. Spatial features are typically derived by analyzing the pixel values and their relationships within a frame or patch.

The term “fragment-aware scanning strategy” refers to a data processing method in which input video data is partitioned into discrete fragments, and the order or manner in which these fragments are processed is selected to preserve spatial or temporal locality, reduce artificial discontinuities, or enhance the extraction of relevant features. Fragment-aware scanning strategies may include, but are not limited to, sequentially scanning fragments within frames, scanning entire fragments across multiple frames before moving to the next fragment, or employing space-filling curves.

### Methods for Evaluating the Perceptual Quality of Digital Video Content

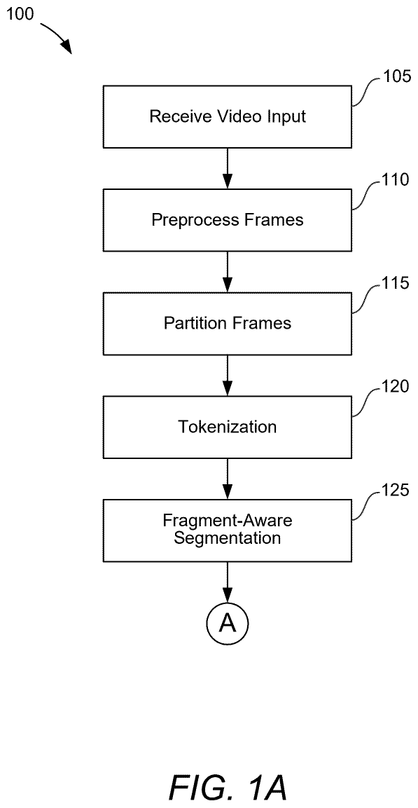

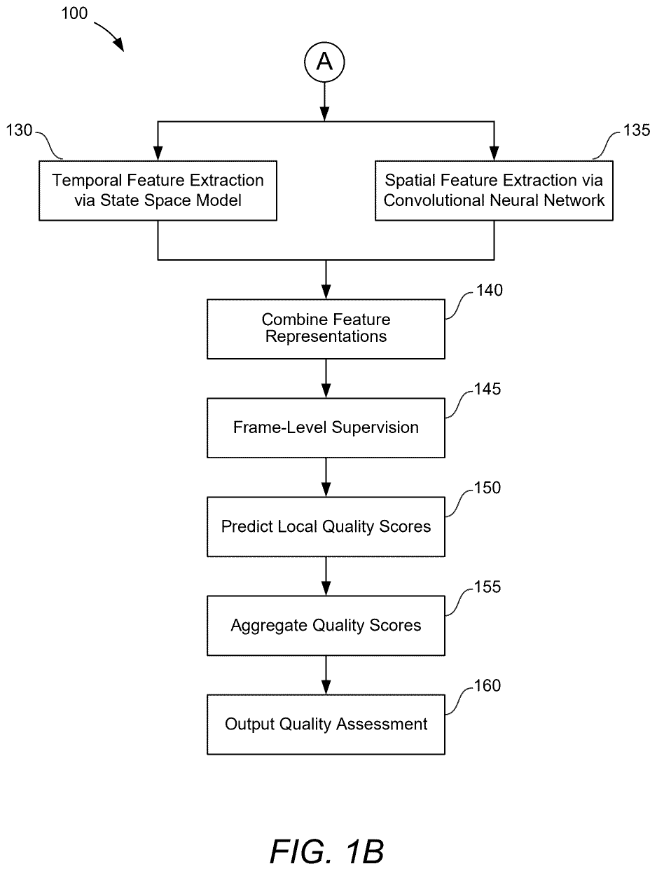

Embodiments disclosed herein pertain to systems and methods for assessing the perceptual quality of digital video content using advanced machine learning architectures that jointly capture both spatial and temporal features. In order to better understand and appreciate the disclosed embodiments, reference is first made to FIGS. 1A and 1B, which present a flowchart depicting the steps associated with a method 100 of automated video quality assessment according to some embodiments.

As shown in FIG. 1A, method 100 begins with receiving a digital video that includes a sequence of video frames representing visual content over time (step 105). The digital video can be obtained from any appropriate source including, as non-limiting examples, a local or remote storage device, a streaming service, or a live capture system. In some implementations, method 100 includes an optional preprocessing step (step 110) that can include one or more operations such as resizing frames, normalizing pixel values, adjusting color channels, or performing other standard image and video normalization steps to ensure compatibility with downstream neural network models. In some implementations, step 110 can be omitted, for example, if the digital video is already in a suitable format.

Each frame of the video is then partitioned into a plurality of fragments (mini-patches) (step 115). Partitioning may be accomplished using a uniform grid, irregular segmentation, or another region-based approach, and is intended to facilitate localized analysis of the video content. The fragments do not represent the entire frame. Instead, the fragments are a sampled subset of regions within the frame. The fragments form a “mosaic” that efficiently samples diverse parts of the frame, rather than covering the entire frame.

In some embodiments, the fragment sampling corresponds to a grid mini-patch sampling (GMS) scheme, in which each frame is partitioned into a uniform grid and a single fragment is sampled from each grid cell so that the set of fragments forms a spatially distributed mosaic that preserves local details without globally resizing the frame

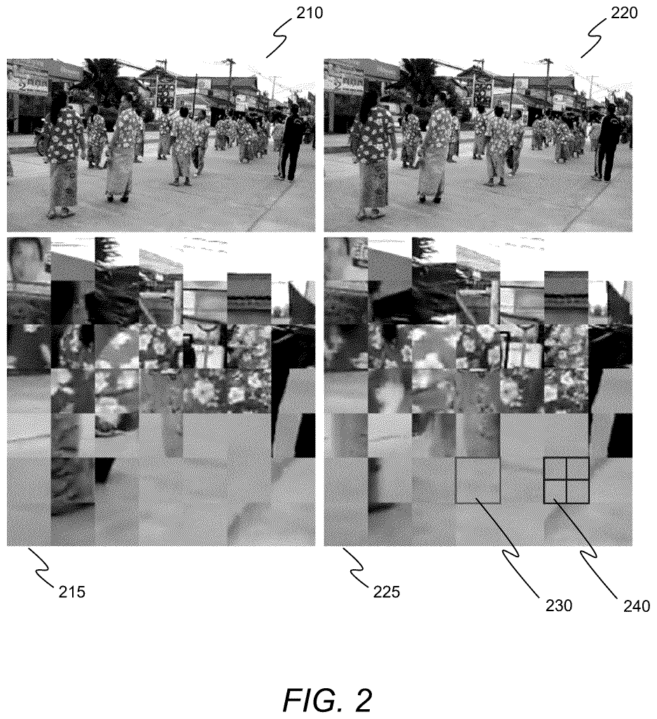

To illustrate the relationship between frames, a uniform grid, fragments (i.e., mini-patches), and patches, reference is made to FIG. 2, which visually demonstrates how input frames are broken down into a grid, how a fragment is selected within each grid cell, and then how that fragment is further partitioned into patches/tokens for input into the neural network. Shown in FIG. 2 are two frames adjacent in time, frames 210 and 220. Each of the frames 210 and 220 has been divided into a spatially uniform grid of non-overlapping grid cells (e.g., a 7×7 grid). While the uniform grid is not displayed over or otherwise visible in frames 210, 220, (and thus the individual grid cells themselves are not visible), within each grid cell a fragment, representing a small portion of the grid cell, is sampled. Thus, where frames 210 and 220 are partitioned into a 7×7 grid, forty-nine (49) fragments are sampled from each frame as shown by the set of fragments 215 (sampled from frame 210) and the set of fragments 225 (sampled from frame 220). As depicted in FIG. 2, an individual fragment 230 within set of fragments 225 is shown as being bounded by a red border.

Within each grid cell, the location of the fragment is typically chosen randomly for each frame, but always within the bounds of that cell. This random sampling avoids bias and helps the model generalize by exposing it to diverse local content over different training samples or frames. The fragments are typically of the same size (e.g., 32×32 pixels), which is small relative to the grid cell and the overall frame.

To promote temporal consistency, fragments are sampled from corresponding grid cells across consecutive frames so that tokens derived from corresponding fragments remain temporally aligned, enabling the model to analyze local content evolution and motion at consistent spatial locations over time.

Nonlimiting, exemplary configurations include grids of m×n cells where m and n are each between 4 and 16, fragment sizes between 16×16 and 64×64 pixels, and patch sizes between 8×8 and 32×32 pixels. Fragments are subdivided into non-overlapping patches that are encoded as tokens for model input. In some embodiments, sequences include 16, 32, or 64 consecutive frames and spatial resolutions of 224×224 or 384×384 (or higher), with the state space model efficiently processing the corresponding token sequences due to its linear computational complexity in sequence length.

Optionally, method 100 can include transforming each fragment or patch into a token (step 120). Tokenization may involve flattening the pixel values of each fragment, projecting the fragment into an embedding space, or otherwise encoding each region into a feature vector suitable for input to neural network models. In some embodiments, tokenization may be integrated with or performed as part of subsequent feature extraction steps.

Also shown in FIG. 2, is a set of four patches 240, which are smaller subdivisions of each fragment. As depicted, if the fragments in FIG. 2 are 32×32 pixels, each individual patch in the set of four patches 240 is a 16×16 pixel patch. The patches 240 serve as tokens for model input. As described later, embodiments use fragments for efficient sampling and spatial alignment across frames, and patches to tokenize fragment content for input to neural networks, enabling fine-grained feature extraction and robust video quality assessment.

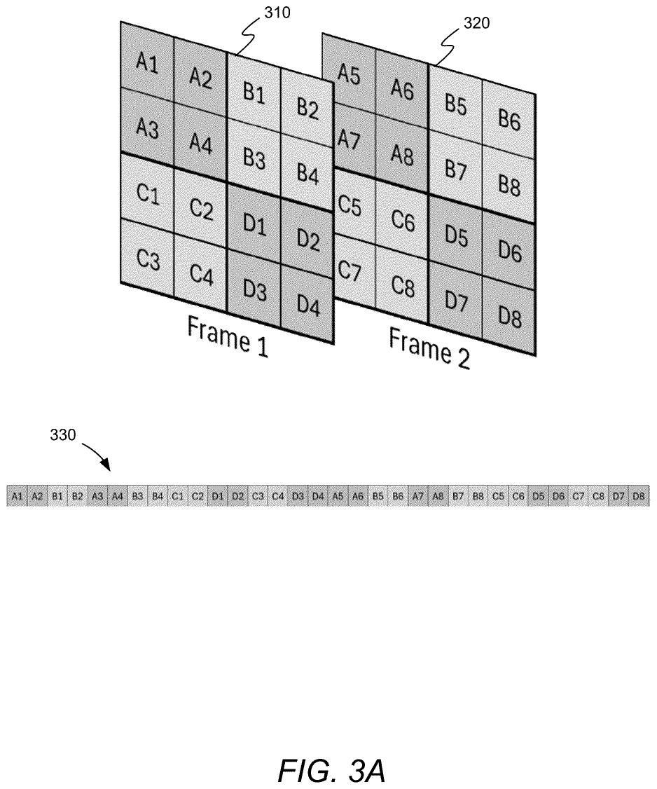

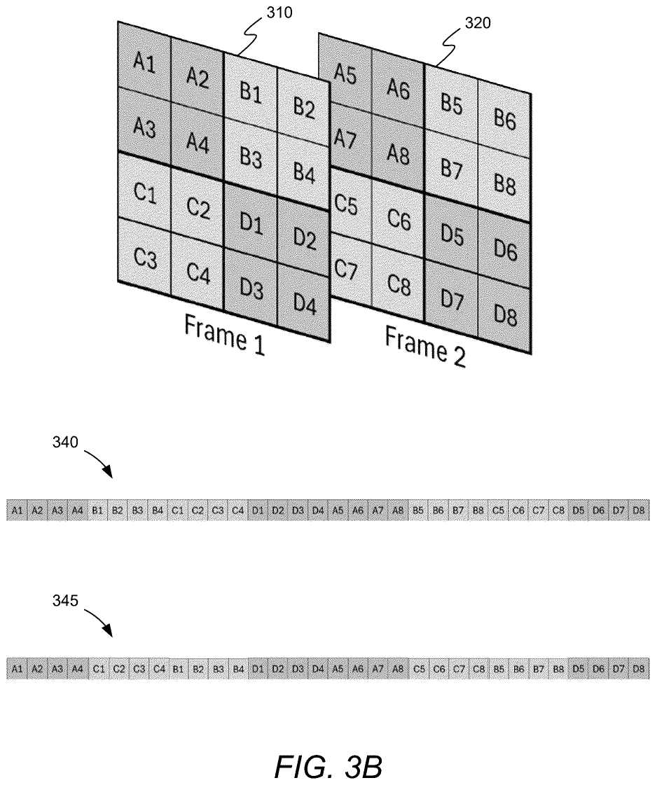

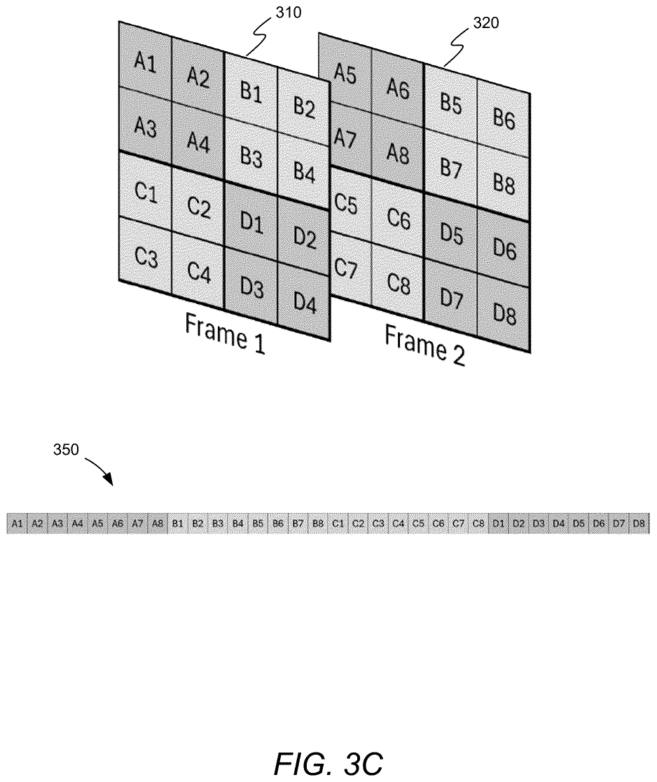

Referring back to FIG. 1, a fragment-aware scanning strategy can be implemented to organize the sequence of tokens for processing by the neural network model (step 125). The scanning strategy determines the order in which the tokens, derived from fragments or patches, are fed into the state space model, and may be selected to preserve spatial and temporal locality, reduce artificial discontinuities, or enhance feature extraction. Different exemplary scanning schemes are illustrated in FIGS. 3A, 3B, and 3C.

FIG. 3A illustrates a default scan scheme (scan sequence 330) as applied to two consecutive frames, frame 310 and frame 320. As depicted, each of frames 310 and 320 includes four fragments A, B, C and D with each fragment including four sequentially numbered tokens arranged in a 2×2 grid. In this scheme, the tokens within each frame are scanned in a conventional row-by-row fashion from left to right, starting from the top row and proceeding downward. The scan sequence 330 traverses all tokens of frame 310 in order before moving on to scan all tokens of frame 320 in the same manner. Thus, the resulting scan sequence 330 results in the tokens being arranged as: A1, A2, B1, B2, A3, A4, B3, B4, C1, C2, D1, D2, C3, C4, D3, D4, A5, A6, B5, B6, A7, A8, B7, B8, C5, C6, D5, D6, C7, C8, D7, D8 as shown. This approach is straightforward to implement and maintains the traditional spatial ordering within each frame.

FIG. 3B depicts a first fragment-aware scan scheme (scan sequence 340), which scans the same frames 310, 320 fragment-by-fragment, rather than row by row. In this arrangement, the scan sequence 340 processes all tokens (e.g., patches) belonging to the first fragment A in frame 310, then proceeds horizontally across the first row of fragments to the next fragment B within the same frame. This process continues in this fashion, scanning all the fragments in the first row, then proceeding to scan the fragments in subsequent rows, until all fragments of frame 310 have been scanned. The process is then repeated for frame 320. Thus, the resulting scan sequence 340 results in the tokens being arranged as: A1, A2, A3, A4, B1, B2, B3, B4, C1, C2, C3, C4, D1, D2, D3, D4, A5, A6, A7, A8, B5, B6, B7, B8, C5, C6, C7, C8, D5, D6, D7, D8 as shown. This fragment-by-fragment, row-based sequence preserves spatial locality within each fragment and may enhance the model's sensitivity to localized distortions or artifacts.

In an alternative implementation of this technique, a scan pattern can scan each frame fragment-by-fragment, following a column-based sequence 345. Thus, for example, the scan sequence 345 processes all tokens (e.g., patches) belonging to the first fragment A in frame 310, then proceeds downward along the first column of fragments to the next fragment C within the same frame. This process continues in this fashion, scanning all the fragments in the first column, then proceeding to scan the fragments in subsequent columns, until all fragments of frame 310 have been scanned. The process is then repeated for frame 320 with the resulting scan sequence 345 results in the tokens being arranged as: A1, A2, A3, A4, C1, C2, C3, C4, B1, B2, B3, B4, D1, D2, D3, D4, A5, A6, A7, A8, C5, C6, C7, C8, B5, B6, B7, B8, D5, D6, D7, D8.

FIG. 3C illustrates a second fragment-aware scan scheme (scan sequence 350), in which the scanning is performed fragment by fragment across frames, rather than within a single frame. In this fragment-by-fragment scan sequence 350, all tokens (patches) of the first fragment A (fragment A) are scanned across both frame 310 and frame 320 in sequence before moving to the next fragment, fragment B. This means that, for a given fragment, the model processes its tokens in all frames before proceeding to the next spatial fragment. Thus, the resulting scan sequence 340 results in the tokens being arranged as: A1, A2, A3, A4, A5, A6, A7, A8, B1, B2, B3, B4, B5, B6, B7, B8, C1, C2, C3, C4, C5, C6, C7, C8, D1, D2, D3, D4, D5, D6, D7, D8 as shown. Such an approach can further strengthen temporal continuity and the model's ability to detect changes or persistence of artifacts across time at specific spatial locations.

In other embodiments, additional scanning strategies can be employed. For example, a Z-scan strategy may traverse tokens in a zig-zag pattern to improve locality, applied horizontally, vertically, or bidirectionally to capture dependencies in both directions. Space-filling curves such as Hilbert or Peano curves may also be used to preserve neighborhood relationships when mapping the 2D frame to a 1D token sequence. Further, a multi-resolution scan may be constructed by interleaving or grouping tokens derived from multiple spatial resolutions, such as globally down-sampled frames or 2D wavelet sub-bands (for example, LL, LH, HL, HH), thereby enabling the model to jointly process global structure and high-frequency artifact details in a single input sequence.

In a wavelet-based multi-resolution implementation, a frame is decomposed into sub-bands by a 2D wavelet transform, tokens are formed per sub-band, and the token sequence is constructed by interleaving or concatenating sub-band tokens by spatial neighborhood and scale so that low-frequency global tokens and high-frequency detail tokens are closely positioned in the sequence. Alternatively, multiple globally downscaled versions of each frame (for example, at one-half and one-quarter resolution) can be generated, tokenized, and sequenced with tokens from the native resolution, with sequencing orders that emphasize locality across scales for corresponding spatial neighborhoods.

Referring back to FIG. 1, temporal feature extraction is then performed by processing the organized sequence of tokens or fragments using a state space model (step 130). The state space model extracts temporal features that capture dependencies and patterns across the video frames, enabling the model to recognize motion, continuity, and other time-dependent aspects of video quality. One example of a suitable state space model is Mamba, which is described in Albert Gu et al., Mamba: Linear-time sequence modeling with selective state spaces, 2023. Embodiments are not limited to using any particular state space model, however, and other suitable state space models, such as Structured State Space for Sequence Model (S4) and Simplified Structured State Space Sequence Model (S5), can be used in other embodiments.

In parallel with or in sequence with step 130, spatial feature extraction is carried out by processing the video frames, fragments, or patches using a convolutional neural network (CNN) (step 135). The CNN extracts spatial features, such as patterns, textures, and local distortions, within individual frames or patches, providing the system with a detailed understanding of spatial quality factors.

The temporal and spatial feature representations are then combined (step 140) to produce a unified feature representation for each frame, fragment, or patch. Combination can be achieved by concatenation of embeddings, weighted summation, attention-based fusion, or other integration techniques, and is intended to leverage the complementary strengths of the state space model and the convolutional neural network.

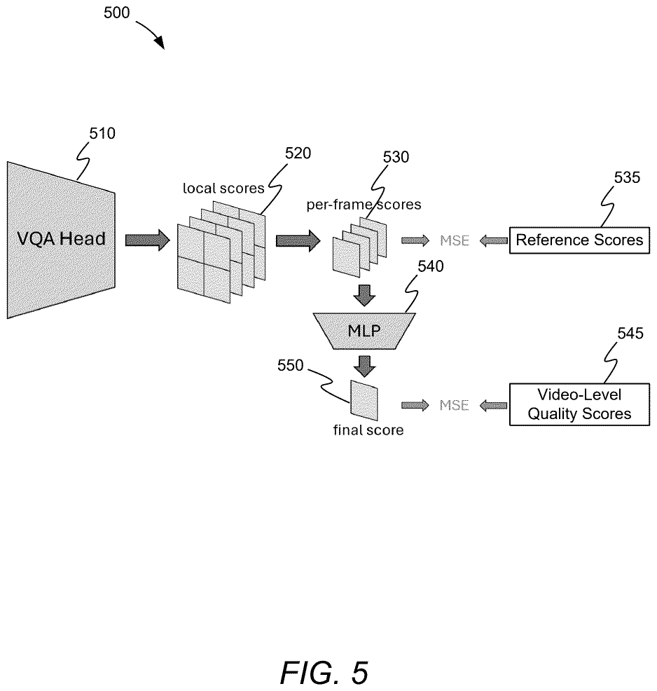

In some embodiments, an optional frame-level supervision step (step 145) may be employed during training. In this step, predicted per-frame or per-patch quality scores are compared to reference scores, such as those produced by a pre-trained image quality model or obtained from human mean opinion scores, and model parameters are updated accordingly to enhance prediction accuracy. Further details of one implementation for step 145 are discussed below in conjunction with FIG. 5.

Based on the unified feature representation, method 100 then predicts local quality scores (step 150). This may be accomplished using additional neural network layers, such as three-dimensional convolutional layers, which regress or classify perceptual quality for each fragment, patch, or frame within the video segment.

After predicting the local quality scores, method 100 then aggregates the scores to produce one or more final quality scores for the input video (step 155). Aggregation may involve averaging, weighted summation, or another statistical or learned fusion approach, and may yield a global video-level score, individual frame-level scores, or both, depending on implementation and use case.

Finally, the quality assessment results are output (step 160) via, for example, a user interface, a downstream processing system, a video delivery pipeline, or any other suitable mechanism. Once output, the video quality scores may be used for video compression optimization, streaming quality adaptation, or other quality-driven video processing tasks.

### Video Quality Assessment Architectural Pipeline

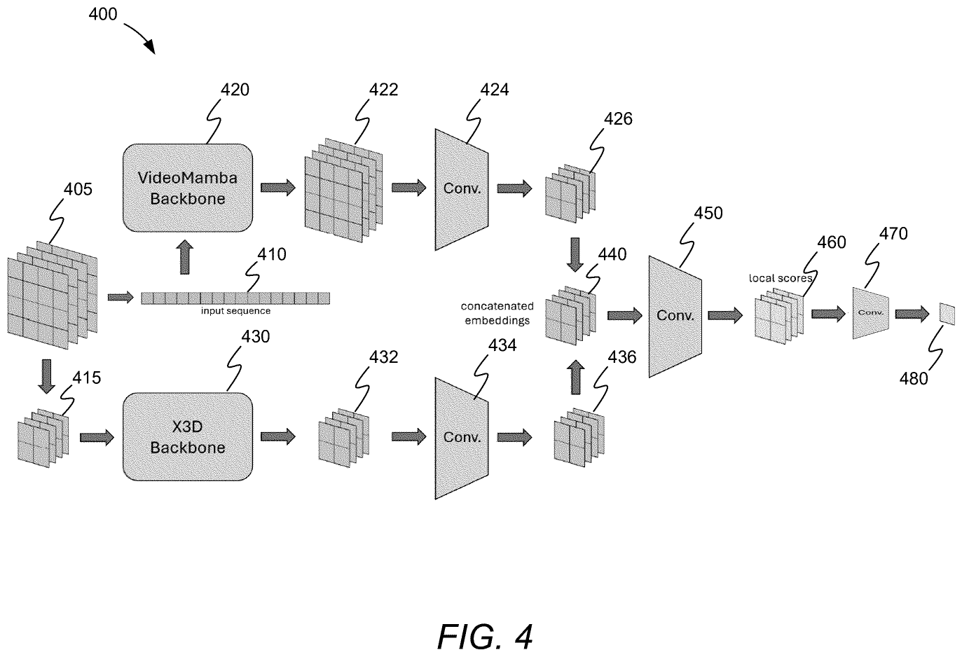

FIG. 4 illustrates an exemplary embodiment of a video quality assessment (VQA) model pipeline 400. Specifically, FIG. 4 provides a high-level overview of the hybrid neural network pipeline that processes digital video input to assess the perceptual quality of digital video content. The hybrid neural network architecture is implemented as a dual-branch system, comprising a first VQA branch utilizing a State Space Model (SSM) backbone (e.g., VideoMamba) and a second VQA branch utilizing a Convolutional Neural Network (CNN) backbone (e.g., X3D).

In a preferred embodiment, this architecture is leveraged to perform dual-perspective quality assessment, which separates the evaluation of high-frequency distortions from overall visual presentation. The first VQA branch is configured as a technical quality branch, receiving raw-resolution fragments (or mini-patches) as input and primarily configured to extract features across the entire temporal sequence, making it highly sensitive to small-scale degradations. The second VQA branch is configured as an aesthetic quality branch, receiving a sequence of resized video frames (e.g., globally downscaled) as input to extract fine-grained spatial and aesthetic features, allowing it to focus on global, perceptual qualities such as color consistency, composition, contrast, and overall aesthetic appeal. Both branches operate concurrently to generate their respective feature representations for subsequent fusion, where the subsequent fusion stage combines a technical, local quality assessment with a global, aesthetic quality assessment to form the unified feature representation. In some embodiments, outputs from the SSM and CNN branches can each be transformed by a three-dimensional convolutional transformation block prior to fusion to align embedding dimensions and spatiotemporal shapes.

A significant advantage of including the State Space Model (SSM) branch in the hybrid model is its linear computational complexity O(L) with respect to the input sequence length (L). This contrasts sharply with the quadratic computational complexity O(L²) of traditional vision transformer models, which are often employed in prior art VQA systems. Due to this linear complexity, the SSM branch is uniquely configured to process an input token sequence of a length (L) that is considerably greater than (e.g., at least twice as large as) a maximum sequence length (Lₘₐₓ) feasible for a vision transformer model of comparable computational resources and latency requirements. This capability allows the SSM branch to capture both higher spatiotemporal resolution (e.g., L corresponding to at least 32 frames or 384×384 pixels per fragment) and longer duration video segments, thereby enhancing the model's ability to perceive complex temporal distortions and overall video narrative flow.

### 1. State Space Model Branch

As depicted in FIG. 4, pipeline 400 begins with receiving a sequence of video frames 405, representing the visual content of a digital video over time. For processing by the state space model, each frame is partitioned into a grid of spatial regions referred to herein as cells, and from each grid cell a fragment is sampled. Within each fragment, the visual content is further subdivided into smaller non-overlapping patches, and each patch is encoded as a token. This hierarchical sampling ensures that both global spatial diversity and local detail are preserved, and that the model receives a representative set of features from across the entire frame.

The tokens derived from all fragments and all frames are then organized into a flat sequence of tokens 410 according to a predetermined scanning strategy, such as one of the scanning strategies discussed above with respect to FIGS. 3A-3C. This sequencing preserves the spatial and temporal context necessary for meaningful feature extraction and enables efficient processing by the neural network.

The flat sequence of tokens 410 is then input to state space model backbone 420, depicted in FIG. 4 as a VideoMamba backbone, and the sequence of embedded tokens 410 is processed by the state space model to efficiently extract temporal features and model long-range dependencies across the sequence of video frames. The output of the state space model backbone 420 is an output sequence of intermediate feature maps 422 for several consecutive frames, which are then processed by a convolutional transformation block 424. The convolutional transformation block 424 applies a three-dimensional convolution to the intermediate feature maps to condense and transform them into a more compact and informative representations 426 suitable for downstream fusion.

### 2. Convolutional Neural Network Branch

In parallel, the original video frames 405 or a preprocessed (e.g., resized) sequence of video frames 415, is input to the convolutional neural network (CNN) branch backbone 430, depicted in FIG. 4 as an X3D backbone. The CNN backbone 430 is configured to extract spatial features and aesthetic qualities from individual frames or frame segments. The output sequence of the CNN backbone includes feature maps 432 that capture detailed spatial and content-driven characteristics of the input frames. These feature maps are then input to a convolutional block 434, which transforms the features into embedding maps 436 (e.g., X3D embedding maps) that are compatible for fusion with representations 426 generated by the state space model branch.

### 3. Unified Representations and Quality Scores

The processed embeddings from both the state space model backbone 420 and the CNN backbone 430 are concatenated along the embedding dimension to form a unified representation 440, which combines both temporal (global, sequence-level) and spatial (local, frame-level) features, ensuring that the model leverages complementary information from both technical and aesthetic perspectives for quality assessment.

The unified representation 440 is then input to a final convolutional prediction head 450, which applies an additional three-dimensional convolution to the fused embeddings. Prediction head 450 generates a set of local quality scores 460, each score corresponding to a specific fragment, patch, or frame region within the input video segment.

The local quality scores 460 are subsequently aggregated, for example, by averaging, weighted summation, or a learned fusion approach, by a score aggregation block 470 to yield a final quality score 480 indicative of the overall perceptual quality of the input digital video. The final quality score 480 may be output to a user interface, a downstream video processing system, or a quality control pipeline for further action.

### Frame-Level Supervision Overview

FIG. 5 illustrates a frame-level supervision pipeline 500 used during training of the video quality assessment (VQA) model according to some embodiments. In particular, FIG. 5 provides an overview of how the per-frame predictions in pipeline 500 are aligned with reference frame-level quality scores to enhance predictive accuracy and model robustness in some embodiments.

As depicted in FIG. 5, pipeline 500 begins with a sequence of video frames, which are processed through the prediction head 510, which can correspond to the prediction head 450 discussed above in conjunction with FIG. 4. Prediction head 510 receives as input the unified feature representation generated by the hybrid neural network architecture described previously. Prediction head 510 outputs a set of local scores 520, where each local score corresponds to a specific fragment, patch, or region within a particular frame. These local scores are then aggregated, such as by averaging across spatial regions, to generate per-frame scores 530, representing the model's predicted assessment of perceptual quality for each individual frame.

During training, the model leverages reference frame-level quality scores 535, which may be obtained from an external image quality assessment model (for example, a state-of-the-art no-reference image quality model) or from human-generated mean opinion scores. In some embodiments, reference scores 535 can be predicted quality scores generated by the MANIQA model (Multi-dimension Attention Network for No-Reference Image Quality Assessment). The model is trained with a loss function, such as a Mean Squared Error (MSE), to quantify errors between its predicted per-frame scores 530 and reference scores 535, providing a strong supervisory signal for network optimization.

To facilitate alignment between the predicted and reference score distributions, which may exist on different, non-aligned scales, dynamic ranges, or statistical properties, a learned mapping module 540 transforms the predicted frame-level quality scores. Mapping module 540, which can include a single fully-connected layer, a multi-layer perceptron (MLP), or a non-linear function such as a logistics curve, is optimized during training to align the distribution of the predicted scores with the distribution of the reference scores, thereby improving the effectiveness and consistency of the frame-level supervision signal.

In addition to frame-level supervision, the model may also utilize reference video-level quality scores 545, which represent the ground-truth or an externally provided assessment of overall perceptual quality for the entire video sequence. The reference video-level quality scores 545 may be generated by aggregating human mean opinion scores, expert ratings, or trusted automated video quality metrics. The final predicted quality score 550, output from pipeline 500, is computed by aggregating the mapped per-frame scores, such as by averaging or weighted summation, and is directly compared to the reference video-level quality score 545 for training and evaluation purposes.

While the description of FIG. 5 above discusses the integration of frame-level supervision pipeline 500 within the hybrid neural network architecture of FIG. 4, in other embodiments, pipeline 500 may be employed to provide additional learning signals beyond those available from video-level or segment-level quality scores in single-backbone models, such as convolutional neural network (CNN) models, state space models, transformer models, or the like. By supervising such models at both the frame and video levels, the system is enabled to deliver more granular and reliable quality predictions, improve model generalization, and enhance utility for applications that require detailed quality feedback, irrespective of the underlying neural network backbone.

### Computer System

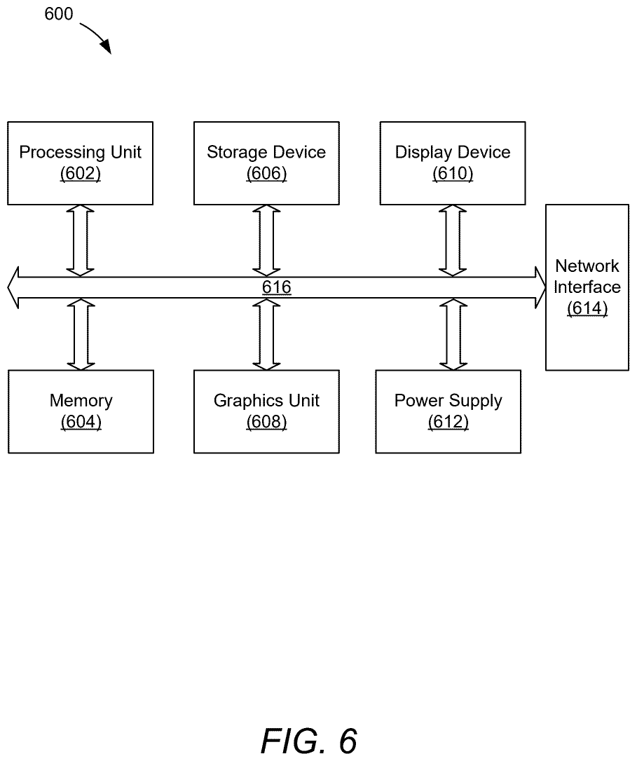

The methods and systems described herein, including those for evaluating the perceptual quality of digital video content using machine learning techniques, may be implemented on a variety of computer systems suitable for graphics processing. Such systems may include, but are not limited to, desktop computers, workstations, servers, cloud-based computing environments, or specialized graphics appliances. Referring now to FIG. 6, an exemplary computer system 600 for graphics processing is illustrated and described below.

Computer system 600 generally includes at least one processor 602, a memory 604, one or more storage devices 606, a graphics processing unit (GPU) 608, a display device 610, one or more input devices 612, and one or more network interfaces 614. These components can be interconnected via a bus or other suitable communication infrastructure 616.

Processor(s) 602 can include one or more central processing units (CPUs), microprocessors, multi-core processors, or combinations thereof. The processor(s) are configured to execute program instructions to perform the steps of the graphics processing methods disclosed herein. Memory 604 can include volatile memory (e.g., random access memory (RAM)), non-volatile memory (e.g., flash, ROM), or combinations thereof. The memory stores program instructions and data that are accessed by the processor(s) during execution of graphics processing tasks.

The one or more storage devices 606 can include hard disk drives (HDDs), solid-state drives (SSDs), optical storage, or other persistent storage media. Storage devices 606 can contain operating system software, application software, graphics libraries, 3D model data, neural network weights, image datasets, and other resources required for graphics processing. Graphics Processing Unit (GPU) 608 can be a specialized hardware component optimized for parallel processing of graphics and image data. GPU 608 can support programmable shader pipelines, CUDA®, OpenCL™, or other parallel computation frameworks, and can include its own dedicated memory. The GPU can be configured to accelerate graphics rendering, machine learning, neural network inference and training, as may be required for methods such as method 100 discussed above.

Display device 610 can include one or more monitors, projectors, virtual reality (VR) headsets, or other devices suitable for presenting visual output generated by the system. Input Devices 612 can keyboards, mice, touchscreens, digitizer tablets, voice input, and/or other user interface devices. Input devices 612 can also include specialized sensors, such as cameras, depth sensors, or motion capture devices, for acquiring data used in graphics processing or avatar creation.

Network interfaces 614 enable communication with other computer systems or devices over a wired or wireless network too allows for distributed or cloud-based processing, remote data acquisition, or collaborative graphics workflows. The bus or communication infrastructure 616 can interconnect all of the above components of system 600 and supports the transfer of data and control signals between them.

Computer system 600 can execute an operating system (e.g., Windows®, macOS®, Linux®), as well as graphics processing software, application-specific modules, and libraries for 3D modeling, rendering, and machine learning (e.g., OpenGL®, Vulkan®, Direct3D®, TensorFlow®, PyTorch®). Program instructions for implementing the methods described herein can be stored in the memory 604 or storage device 606 and executed by the processor(s) 602 and/or GPU 608. Such instructions can be embodied as software modules, plug-ins, or as part of a larger graphics application or pipeline.

In some embodiments, computer system 600 can be part of a distributed computing environment or cloud infrastructure. For example, graphics processing and neural network training may be performed on a cluster of networked servers or in a cloud-based GPU instance, with data and results transmitted to and from client devices via the network interfaces 614.

It will be understood that the configuration of computer system 600 is illustrative and not limiting. In various embodiments, system 600 can include additional hardware components (e.g., FPGAs, ASICs), omit certain components, or be integrated into a mobile device, embedded system, or dedicated appliance.

Additionally, while computer system 600 can implement methods 100 and 200 described above, it is to be understood that software and hardware that is part of the computer system can be viewed as including different modular systems or components that perform various steps of the described methods and/or stages of the described pipelines.

### Additional Embodiments

In addition to the methods described above, embodiments of the present disclosure are also directed to systems and devices that can be used to execute such methods. For example, one embodiment is directed to a computer system, such as the computer system described with respect to FIG. 6, which includes a processor and a non-transitory computer readable medium coupled to the processor, in which the non-transitory computer readable medium stores computer instructions that, when executed by the processor, can implement any of the computer-implemented methods described herein, including method 100 and can implement the pipelines 400 and 500 described herein.

For purposes of explanation, the foregoing description used specific nomenclature to provide a thorough understanding of the described embodiments. However, it will be apparent to one skilled in the art that some specific details are not required in order to practice the described embodiments. Thus, the foregoing descriptions of the specific embodiments described herein are presented for purposes of illustration and description. They are not intended to be exhaustive or to limit the embodiments to the precise forms or implementations disclosed.

Also, while different embodiments of the invention were disclosed above, the specific details of particular embodiments may be combined in any suitable manner without departing from the spirit and scope of embodiments of the invention. Further, it will be apparent to one of ordinary skill in the art that many modifications and variations are possible in view of the above teachings.

What is claimed is:

1. A computer-implemented method for assessing a quality of a digital video, comprising:
receiving, by one or more processors, a digital video comprising a sequence of video frames;
processing the video frames, by a hybrid neural network architecture comprising a first visual quality assessment (VQA) branch utilizing a state space model and a second VQA branch utilizing a convolutional neural network, wherein the first VQA branch extracts temporal features from the sequence of video frames by the state space model and the second VQA branch extracts spatial features from individual frames by the convolutional neural network;
combining the temporal and spatial features to form a unified feature representation; and
generating, by the neural network architecture using the unified feature representation, at least one quality score indicative of a perceptual quality of the digital video.

2. The method of claim 1, further comprising generating a quality score for each frame of the video, in addition to the at least one quality score for the sequence.

3. The method of claim 1, further comprising providing frame-level supervision during training by comparing predicted frame-level quality scores to reference scores generated by a pre-trained image quality assessment model, and transforming the predicted frame-level quality scores via a learned mapping module to align with a distribution of the reference scores.

4. The method of claim 1, wherein receiving and processing the video frames comprises partitioning each frame into a grid of spatially uniform non-overlapping grid cells, and sampling a fragment from each grid cell.

5. The method of claim 4, wherein sampling a fragment from each grid cell comprises subdividing each fragment into a plurality of non-overlapping patches, and encoding each patch as a token for input to the neural network architecture.

6. The method of claim 5, further comprising organizing the tokens into a sequence according to a fragment-aware scanning strategy.

7. The method of claim 6, wherein the fragment-aware scanning strategy comprises scanning each frame fragment by fragment in sequence.

8. The method of claim 6, wherein the fragment-aware scanning strategy comprises scanning all tokens of a fragment across multiple frames before moving to the next fragment.

9. The method of claim 1, wherein the state space model comprises an input-dependent, selective state space model.

10. The method of claim 1, wherein the unified feature representation is processed by a series of three-dimensional convolutional layers to regress local quality scores for each fragment or patch.

11. The method of claim 1, wherein the at least one quality score is computed by aggregating local quality scores across all fragments, patches, or frames using averaging, weighted summation, or a learned fusion method.

12. The method of claim 1, further comprising outputting the at least one quality score to a video streaming optimization, compression, or quality monitoring system.

13. The method of claim 1, wherein the state space model is configured to process an input token sequence of a length (L) that is at least twice a maximum sequence length (Lₘₐₓ) feasible for a Vision Transformer model of comparable computational resources, due to the linear computational complexity of the state space model.

14. The method of claim 1, wherein the first VQA branch is configured as a technical quality branch that receives fragments sampled from raw-resolution frames without global downscaling, and the second VQA branch is configured as an aesthetic quality branch that receives globally resized frames.

15. A system comprising one or more processors and a non-transitory computer-readable medium storing instructions that, when executed by the one or more processors, cause the system to:
receive a digital video comprising a sequence of video frames;
process the video frames, by a hybrid neural network architecture comprising a first visual quality assessment (VQA) branch utilizing a state space model and a second VQA branch utilizing a convolutional neural network, wherein the first VQA branch extracts temporal features from the sequence of video frames by the state space model and the second VQA branch extracts spatial features from individual frames by the convolutional neural network;
combine the temporal and spatial features to form a unified feature representation; and
generate by the neural network architecture using the unified feature representation, at least one quality score indicative of a perceptual quality of the digital video.

16. The system set forth in claim 15 wherein the instructions stored in the computer-readable memory further cause the system to generate a quality score for each frame of the video, in addition to the at least one quality score for the sequence.

17. The system set forth in claim 15 wherein the instructions stored in the computer-readable memory further cause the system to provide frame-level supervision during training by comparing predicted frame-level quality scores to reference scores generated by a pre-trained image quality assessment model, and transform the predicted frame-level quality scores via a learned mapping module to align with a distribution of the reference scores.

18. A non-transitory computer-readable medium storing instructions that, when executed by one or more processors, cause the one or more processors to:
receive a digital video comprising a sequence of video frames;
process the video frames, by a hybrid neural network architecture comprising a first visual quality assessment (VQA) branch utilizing a state space model and a second VQA branch utilizing a convolutional neural network, wherein the first VQA branch extracts temporal features from the sequence of video frames by the state space model and the second VQA branch extracts spatial features from individual frames by the convolutional neural network;
combine the temporal and spatial features to form a unified feature representation; and
generate by the neural network architecture using the unified feature representation, at least one quality score indicative of a perceptual quality of the digital video.

19. The non-transitory computer-readable medium set forth in claim 18 wherein the instructions, when executed by the one or more processors, cause the one or more processors to generate a quality score for each frame of the video, in addition to the at least one quality score for the sequence.

20. The non-transitory computer-readable medium set forth in claim 18 wherein the instructions, when executed by the one or more processors, cause the one or more processors to provide frame-level supervision during training by comparing predicted frame-level quality scores to reference scores generated by a pre-trained image quality assessment model, and transform the predicted frame-level quality scores via a learned mapping module to align with a distribution of the reference scores.
